(19) United States
(12) Patent Application Publication
(10) Pub. No.: US 2021/0043963 A1
(43) Pub. Date: Feb. 11, 2021

(54) METHOD OF MANUFACTURING SULFIDE SOLID ELECTROLYTE AND SULFIDE SOLID ELECTROLYTE MANUFACTURED THEREBY

(71) Applicants: HYUNDAI MOTOR COMPANY, SEOUL (KR); KIA MOTORS CORPORATION, SEOUL (KR); HANSOL CHEMICAL CO., LTD., SEOUL (KR)

(72) Inventors: In Woo Song, Gwacheon-si (KR); Hong Seok Min, Yongin-si (KR); Yong Jun Jang, Seongnam-si (KR); Sa Heum Kim, Suwon-si (KR); So Young Yoon, Bongdong-eup (KR); Yung Sup Youn, Bongdong-eup (KR); Kyung Ho Kim, Bongdong-eup (KR); Sang Wook Han, Bongdong-eup (KR); Se Man Kwon, Bongdong-eup (KR)

(21) Appl. No.: 16/878,777

(22) Filed: May 20, 2020

(30) Foreign Application Priority Data
Aug. 9, 2019 (KR) 10-2019-0097268

(51) Int. Cl. H01M 10/056; H01M 10/052; H01M 10/058

(52) U.S. Cl. CPC H01M 10/056; H01M 10/058; H01M 10/052

(57) ABSTRACT

The present disclosure relates to a method of manufacturing a sulfide solid electrolyte and a sulfide solid electrolyte manufactured thereby, and more particularly to a method of manufacturing a sulfide solid electrolyte and a sulfide solid electrolyte manufactured thereby, in which the sulfide solid electrolyte includes two or more sulfide compounds, thus improving the atmospheric stability of the solid electrolyte and reducing the generation of toxic gas.

### CROSS REFERENCE TO RELATED APPLICATIONS

The present application claims priority based on Korean Patent Application No. 10-2019-0097268, filed on Aug. 9, 2019, the entire content of which is incorporated herein for all purposes by this reference.

### BACKGROUND

### 1. Technical Field

The present disclosure relates to a method of manufacturing a sulfide solid electrolyte and a sulfide solid electrolyte manufactured thereby, and more particularly to a method of manufacturing a sulfide solid electrolyte and a sulfide solid electrolyte manufactured thereby, in which the sulfide solid electrolyte includes two or more sulfide compounds, thus improving the atmospheric stability of the solid electrolyte and reducing the generation of toxic gas.

### 2. Description of the Related Art

Nowadays, rechargeable batteries are widely utilized as small high-performance energy sources for portable electronic devices such as mobile phones, camcorders, laptop computers and the like and large-capacity power storage batteries for use in electric vehicles or electric power storage systems.

Lithium-ion batteries are advantageously used as secondary batteries because of the high energy density and large capacity per unit area thereof compared to nickel-manganese batteries and nickel-cadmium batteries.

However, conventional lithium-ion batteries mainly use a flammable organic liquid electrolyte as an electrolyte and thus have a safety problem due to overheating. Recently, all-solid-state batteries using nonflammable solid electrolytes are receiving attention.

As for all-solid-state batteries, the movement of lithium ions at the interface between the electrode and the electrolyte has emerged as an important issue. This is because a lithium-ion depletion layer is formed at the interface between the sulfide solid electrolyte and the oxide electrode material, thereby generating large interfacial resistance, which causes problems such as decreased battery capacity, a shortened lifetime, etc.

Therefore, in order to reduce interfacial resistance in conventional all-solid-state batteries, a method of coating the surface of the cathode active material with an oxide is devised. However, there still exist problems in which the coating layer may be easily broken by external pressure during the process of manufacturing a battery, including pressing, etc., or in which the coating layer may be damaged by changes in the volume of the cathode active material during charging and discharging of the battery.

In this regard, a method and structure for manufacturing a sulfide solid electrolyte having reduced interfacial resistance between the electrode and the solid electrolyte is required.

### SUMMARY

Accordingly, the present disclosure has been made keeping in mind the problems encountered in the related art, and an objective of the present disclosure is to provide a method of manufacturing a sulfide solid electrolyte and a sulfide solid electrolyte manufactured thereby, in which the sulfide solid electrolyte includes two or more sulfide compounds, thus improving the atmospheric stability of the solid electrolyte and reducing the generation of toxic gas.

Another objective of the present disclosure is to provide a method of manufacturing a sulfide solid electrolyte and a sulfide solid electrolyte manufactured thereby, in which a sulfide compound complex is pulverized to a uniform particle size, thereby reducing the interfacial resistance of the solid electrolyte to thus decrease damage to the surface thereof that is in contact with the atmosphere.

An embodiment of the present disclosure provides a method of manufacturing a sulfide solid electrolyte, including preparing a powder by dissolving lithium sulfide (Li₂S), a sulfur compound, a first lithium halide and a second lithium halide in an organic solvent and performing drying, preparing a sulfide compound complex including two or more sulfide compounds by thermally treating the powder, and pulverizing the sulfide compound complex.

In an exemplary embodiment, the organic solvent may include any one of dimethyl formamide (DMF) and tetrahydrofuran (THF).

In an exemplary embodiment, the sulfur compound may include any one of silicon sulfide, phosphorus sulfide, germanium sulfide and boron sulfide.

In an exemplary embodiment, the first lithium halide and the second lithium halide may have a composition of LiX (in which X includes any one element of Cl, Br and I).

In an exemplary embodiment, the sulfide compound complex may be a complex including two or more sulfide compounds having compositions of LPS (LiₓP_{y}S_{z}) and LPSX (LiₓP_{y}S_{z}X, in which X includes any one element of Cl, Br and I).

In an exemplary embodiment, the sulfide compound complex may be a complex of two or more selected from among Li₆PS₅Cl, Li₆PS₅Br, Li₃PS₄ and Li₇P₃S₁₁.

In an exemplary embodiment, in the preparing the powder, a molar ratio of the lithium sulfide to the sulfur compound to the first lithium halide to the second lithium halide may be 3:0.5:0.5:0.5, and the organic solvent in which the lithium sulfide (Li₂S), the sulfur compound, the first lithium halide and the second lithium halide are dissolved may be dried at 80 to 150° C.

In an exemplary embodiment, the thermally treating may include treating the powder at a temperature of 300 to 500° C. for 5 to 24 hr.

Another embodiment of the present disclosure provides a sulfide solid electrolyte, including a sulfide compound complex including two or more sulfide compounds selected from among Li₆PS₅Cl, Li₆PS₅Br, Li₃PS₄ and Li₇P₃S₁₁.

In an exemplary embodiment, the sulfide compound complex may have a particle size of 0.5 to 10 μm.

According to the present disclosure, the sulfide solid electrolyte includes two or more sulfide compounds, thereby improving the atmospheric stability of the solid electrolyte and reducing the generation of toxic gas.

Moreover, a sulfide compound complex is pulverized to a uniform particle size, thereby reducing the interfacial resistance of the solid electrolyte to thus decrease damage to the surface thereof that is in contact with the atmosphere.

### BRIEF DESCRIPTION OF THE FIGURE

FIG. 1 is a flowchart showing a process of manufacturing a sulfide solid electrolyte according to an embodiment of the present disclosure.

### DETAILED DESCRIPTION

The disclosure will be described in detail with reference to the accompanying drawings. Repeated descriptions and detailed descriptions of known functions and configurations that may obscure the gist of the present disclosure will be omitted. The embodiments of the present disclosure are provided to more fully describe the present disclosure to those skilled in the art. Accordingly, the shapes and sizes of the elements in the drawings and the like may be exaggerated for clarity.

It is also to be understood that when any part is referred to as “comprising” or “including” any element, this does not exclude other elements, but may further include other elements unless otherwise stated.

A better understanding of the present disclosure will be given through the following preferred embodiments, which are merely set forth to more easily explain the present disclosure but are not to be construed as limiting the present disclosure.

### <Method of Manufacturing Sulfide Solid Electrolyte>

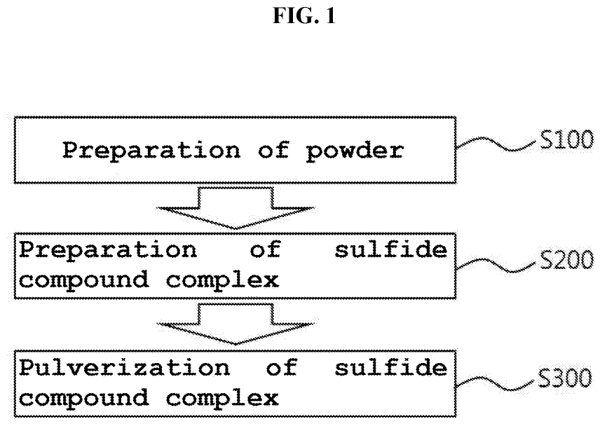

FIG. 1 is a flowchart showing the process of manufacturing the sulfide solid electrolyte according to an embodiment of the present disclosure.

The method of manufacturing the sulfide solid electrolyte includes preparing a powder (S100), preparing a sulfide compound complex (S200), and pulverizing the sulfide compound complex (S300).

The preparing the powder (S100) may include dissolving lithium sulfide (Li₂S) and a sulfur compound in an organic solvent, reacting two different lithium halides in the organic solvent in which lithium sulfide (Li₂S) and the sulfur compound are dissolved, and drying the organic solvent, thus obtaining the powder.

Here, the organic solvent may include any one of dimethyl formamide (DMF) and tetrahydrofuran (THF), and the sulfur compound may include any one of silicon sulfide, phosphorus sulfide, germanium sulfide and boron sulfide. Also, the lithium halide has a composition of LiX (X including any one element of Cl, Br and I).

In the preparing the powder (S100), the lithium sulfide (Li₂S), sulfur compound, first lithium halide and second lithium halide may be dissolved at a molar ratio of 2:0.1:0.1:0.1 to 4:1:1:1 in the organic solvent.

Moreover, in the preparing the powder (S100), the lithium sulfide (Li₂S) and the sulfur compound are completely dissolved at a molar ratio of 2:0.1 to 4:1 in the organic solvent, after which the first lithium halide and the second lithium halide may be mixed and reacted at the same molar ratio as the sulfur compound in the organic solvent. Here, the reaction time may fall in the range of 12 to 24 hr. If the reaction time is less than 12 hr, the lithium sulfide, sulfur compound and lithium halides do not react with each other, undesirably making it difficult to produce sulfide compounds.

In the preparing the powder by drying the organic solvent, the drying temperature may fall in the range of 80 to 150° C. If the drying temperature of the organic solvent is lower than 80° C., the time required to evaporate the solvent may increase. On the other hand, if the drying temperature thereof is higher than 150° C., sulfur (S) may evaporate together with the solvent, thus making it impossible to manufacture a sulfide compound complex.

In the preparing the powder (S100) according to an exemplary embodiment, lithium sulfide (Li₂S) and phosphorus pentasulfide (P₂S₅) are dissolved at a molar ratio of 3:0.5 in a tetrahydrofuran (THF) solvent, after which lithium chloride (LiCl) and lithium bromide (LiBr) are mixed at a molar ratio of 0.5:0.5 and allowed to react for 24 hr. Drying is then performed at 100° C., thereby obtaining a powder.

In the preparing the sulfide compound complex (S200), the powder obtained in S100 is thermally treated, thus obtaining a complex including two or more sulfide compounds.

More specifically, in the preparing the sulfide compound complex (S200), the thermal treatment is performed at a temperature of 300 to 500° C. for 5 to 24 hr, thus preparing two or more sulfide compounds.

Here, if the thermal treatment temperature and time are less than 350° C. and 5 hr, respectively, the sulfide compounds may not be synthesized. On the other hand, if the thermal treatment temperature and time exceed 500° C. and 24 hr, respectively, the evaporation of sulfur (S) may increase, and thus the sulfide compound phase may be converted into Li₃PS₄, which is undesirable.

The sulfide compounds obtained in the preparing the sulfide compound complex (S200) may have compositions of LPS(LiₓP_{y}S_{z}) and LPSX(LiₓP_{y}S_{z}X, in which X includes any one element of Cl, Br and I).

Moreover, the sulfide compound complex according to the present disclosure includes two or more sulfide compounds selected from among Li₆PS₅Cl, Li₆PS₅Br, Li₃PS₄ and Li₇P₃S₁₁. When the powder is thermally treated, sulfide compounds having compositions of Li₆PS₅Cl, Li₆PS₅Br, Li₃PS₄ and Li₇P₃S₁₁ are produced, and a complex structure including the sulfide compounds is manufactured. The complex structure may be provided in the form of a sphere, core-shell, or stack.

The sulfide compound complex according to the present disclosure includes sulfide compounds, whereby the surface of the sulfide solid electrolyte that is in contact with the atmosphere is provided with the sulfide compounds, ultimately improving the atmospheric stability of the solid electrolyte and reducing the generation of toxic gas.

In the pulverizing the sulfide compound complex (S300), the sulfide compound complex is pulverized to a predetermined particle size using a solution distribution process.

The solution distribution process is performed in a manner in which the sulfide compound complex obtained through S100 and S200 is dispersed in a nonpolar solvent, particularly a toluene solvent, and is then uniformly pulverized using a mill.

In an exemplary embodiment, the mill may be a rotary mill, and the rotary mill may operate at a speed of 500 to 2000 rpm for 5 min to 5 hr. If the operating speed and time of the rotary mill are less than 500 rpm and 5 min, respectively, the time required to pulverize the sulfide compound complex is insufficient, and thus uniformly distributed particles may not be obtained. On the other hand, if the operating speed and time of the rotary mill respectively exceed 2000 rpm and 5 hr, the pulverized particles may aggregate, which is undesirable.

### <Sulfide Solid Electrolyte>

According to the present disclosure, the sulfide solid electrolyte includes a sulfide compound complex composed of two or more sulfide compounds selected from among Li₆PS₅Cl, Li₆PS₅Br, Li₃PS₄ and Li₇P₃S₁₁.

The sulfide compound complex may have a particle size of 0.5 to 10 μm, particularly D10 of 500 nm to 2 μm, D50 of 1 μm to 5 μm and D90 of 5 μm to 10 μm.

The sulfide solid electrolyte according to the present disclosure includes the sulfide compound complex the particles of which are uniform, thereby effectively reducing the interfacial resistance of the electrolyte.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

1. A method of manufacturing a sulfide solid electrolyte, comprising:
preparing a powder by dissolving lithium sulfide (Li₂S), a sulfur compound, a first lithium halide and a second lithium halide in an organic solvent and performing drying;
preparing a sulfide compound complex comprising two or more sulfide compounds by thermally treating the powder; and
pulverizing the sulfide compound complex.

2. The method of claim 1, wherein the organic solvent comprises any one of dimethyl formamide (DMF) and tetrahydrofuran (THF).

3. The method of claim 1, wherein the sulfur compound comprises any one of silicon sulfide, phosphorus sulfide, germanium sulfide and boron sulfide.

4. The method of claim 1, wherein the first lithium halide and the second lithium halide have a composition of LiX (in which X comprises any one element of Cl, Br and I).

5. The method of claim 1, wherein the sulfide compound complex is a complex comprising two or more sulfide compounds having compositions of LPS(LiₓP_{y}S_{z}) and LPSX(LiₓP_{y}S_{z}X, in which X comprises any one element of Cl, Br and I).

6. The method of claim 5, wherein the sulfide compound complex is a complex of two or more selected from among Li₆PS₅Cl, Li₆PS₅Br, Li₃PS₄ and Li₇P₃S₁₁.

7. The method of claim 1, wherein in the preparing the powder, a molar ratio of the lithium sulfide to the sulfur compound to the first lithium halide to the second lithium halide is 3:0.5:0.5:0.5, and
the organic solvent in which the lithium sulfide (Li₂S), the sulfur compound, the first lithium halide and the second lithium halide are dissolved is dried at 80 to 150° C.

8. The method of claim 1, wherein the thermally treating comprises treating the powder at a temperature of 300 to 500° C. for 5 to 24 hr.

9. A sulfide solid electrolyte, comprising a sulfide compound complex comprising two or more sulfide compounds selected from among Li₆PS₅Cl, Li₆PS₅Br, Li₃PS₄ and Li₇P₃S₁₁.

10. The sulfide solid electrolyte of claim 9, wherein the sulfide compound complex has a particle size of 0.5 to 10 μm.
